(19) United States
(12) Patent Application Publication
(10) Pub. No.: US 2021/0304170 A1
(43) Pub. Date: Sep. 30, 2021

(54) SETTLEMENT SYSTEM, TERMINAL DEVICE, AND COMPUTER READABLE RECORDING MEDIUM

(71) Applicant: TOYOTA JIDOSHA KABUSHIKI KAISHA, Toyota-shi (JP)

(72) Inventors: Yoshihiko TAKAHASHI, Miyoshi-shi (JP); Yuki TATSUMOTO, Miyoshi-shi (JP); Keisuke NISHINAKA, Nagoya-shi (JP); Hiroki TAMURA, Shinagawa-ku (JP); Yoshitaka NISHIKAWA, Nagakute-shi (JP); Kenji GOTOH, Minato-ku (JP); Kota KATO, Abiko-shi (JP)

(73) Assignee: TOYOTA JIDOSHA KABUSHIKI KAISHA, Toyota-shi (JP)

(21) Appl. No.: 17/212,139

(22) Filed: Mar. 25, 2021

(30) Foreign Application Priority Data
Mar. 31, 2020 (JP) 2020-061955

(51) Int. Cl. G06Q 20/14; G06Q 20/10; G07B 15/06; G06Q 20/32

(52) U.S. Cl. CPC G06Q 20/145; G06Q 20/3278; G07B 15/06; G06Q 20/102

(57) ABSTRACT

A settlement system includes: a terminal device configured to be carried by a first user, the terminal device including a first processor including hardware, the first processor being configured to output user information indicating a second user who pays a cost for traveling a vehicle by the first user; and a server including a second processor including hardware, the second processor being configured to acquire the user information, and execute settlement processing by the second user indicated by the user information for the cost for traveling the vehicle with the terminal device.

The present application claims priority to and incorporates by reference the entire contents of Japanese Patent Application No. 2020-061955 filed in Japan on Mar. 31, 2020.

### BACKGROUND

The present disclosure relates to a settlement system, a terminal device, and a computer readable recording medium.

JP 2010-61236 A discloses an in-vehicle settlement system that performs settlement of a price for service provision while a driver is riding in a vehicle.

### SUMMARY

There is a need for a settlement system, a terminal device, and a computer readable recording medium that improve convenience of a settlement service.

According to one aspect of the present disclosure, there is provided a settlement system including: a terminal device configured to be carried by a first user, the terminal device including a first processor including hardware, the first processor being configured to output user information indicating a second user who pays a cost for traveling a vehicle by the first user; and a server including a second processor including hardware, the second processor being configured to acquire the user information, and execute settlement processing by the second user indicated by the user information for the cost for traveling the vehicle with the terminal device.

### BRIEF DESCRIPTION OF THE DRAWINGS

FIG. 1 is a schematic diagram illustrating a configuration of a wallet system according to an embodiment;

FIG. 2 is a block diagram illustrating a configuration of a wallet server illustrated in FIG. 1;

FIG. 3 is a block diagram illustrating a configuration of a settlement provider server illustrated in FIG. 1;

FIG. 4 is a block diagram illustrating a configuration of a user terminal illustrated in FIG. 1;

FIG. 5 is a diagram illustrating a relationship between a wallet and a settlement method;

FIG. 6 is a block diagram illustrating a configuration of a vehicle illustrated in FIG. 1;

FIG. 7 is a timing chart illustrating a flow of recording processing according to an embodiment; and

FIG. 8 is a timing chart illustrating a flow of settlement processing according to an embodiment.

### DETAILED DESCRIPTION

Hereinafter, a wallet system according to an embodiment will be described with reference to the drawings.

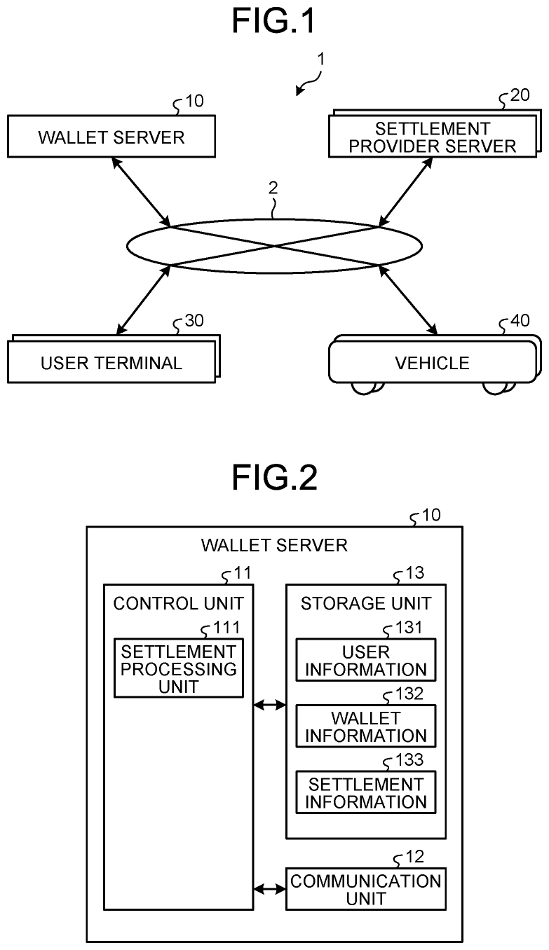

First, a configuration of a wallet system according to an embodiment will be described with reference to FIGS. 1 to 6.

As illustrated in FIG. 1, a wallet system 1 according to an embodiment includes a wallet server 10, a settlement provider server 20, a user terminal 30, and a vehicle 40 that perform information communication with each other via a network 2.

The network 2 includes an Internet line network, a mobile phone line network, and the like. The network 2 is, for example, a public communication network such as the Internet, and may include other communication networks such as a wide area network (WAN), a telephone communication network for a mobile phone and the like, and a wireless communication network such as WiFi (registered trademark).

The wallet server 10 is an information processing device that comprehensively manages the wallet system 1, and is managed by an administrator of the wallet system 1. As illustrated in FIG. 2, the wallet server 10 includes a control unit 11, a communication unit 12, and a storage unit 13.

The control unit 11 includes a processor having hardware, such as a central processing unit (CPU), a digital signal processor (DSP), and a field-programmable gate array (FPGA), and a main storage unit such as a random access memory (RAM) and a read only memory (ROM). The control unit 11 loads a computer program stored in the storage unit 13 in a work area of the main storage unit, executes the computer program, and controls each component or the like through the execution of the computer program, thereby implementing a function matching a predetermined purpose. In the present embodiment, the control unit 11 functions as a settlement processing unit 111 by executing the computer program. A function of the settlement processing unit 111 will be described later.

The communication unit 12 includes, for example, a local area network (LAN) interface board and a wireless communication circuit for wireless communication. The LAN interface board and the wireless communication circuit are connected to the network 2 such as the Internet serving as a public communication network. The communication unit 12 is connected to the network 2 and performs information communication with the settlement provider server 20, the user terminal 30, and the vehicle 40 via the network 2.

The storage unit 13 includes a recording medium such as an erasable programmable ROM (EPROM), a hard disk drive (HDD), and a removable medium. Examples of the removable medium include a disc recording medium such as a universal serial bus (USB) memory, a compact disc (CD), a digital versatile disc (DVD), and a Blu-ray (registered trademark) disc (BD). The storage unit 13 may store an operating system (OS), various programs, various tables, various databases, and the like. In the present embodiment, the storage unit 13 stores user information 131, wallet information 132, and settlement information 133 for each user who uses the wallet system 1.

The user information 131 is information regarding a user who uses the wallet system 1. Examples of the user information 131 include a user ID of the user who has registered to use the wallet system 1, a password, a name of the user, contact information (for example, address, phone number, and email address) of the user, a use registration history, information regarding a payment method registered as a depositing method, information regarding a payment method registered as a settlement method, and a personal identification number at the time of settlement. In the user information 131, the user ID and the password are used for authentication processing such as login to the wallet server 10.

The wallet information 132 is information regarding a wallet of the wallet system 1. The wallet indicates a virtual deposit/withdrawal account of electronic money. Examples of the wallet information 132 include a user ID, a balance of electronic money, a deposit history of electronic money, and a use history of electronic money.

The settlement information 133 is information regarding settlement of the wallet system 1. Examples of the settlement information 133 include a user ID, a settlement method used for the settlement (for example, electronic money payment (contactless payment), scan payment, and code payment), and settlement history.

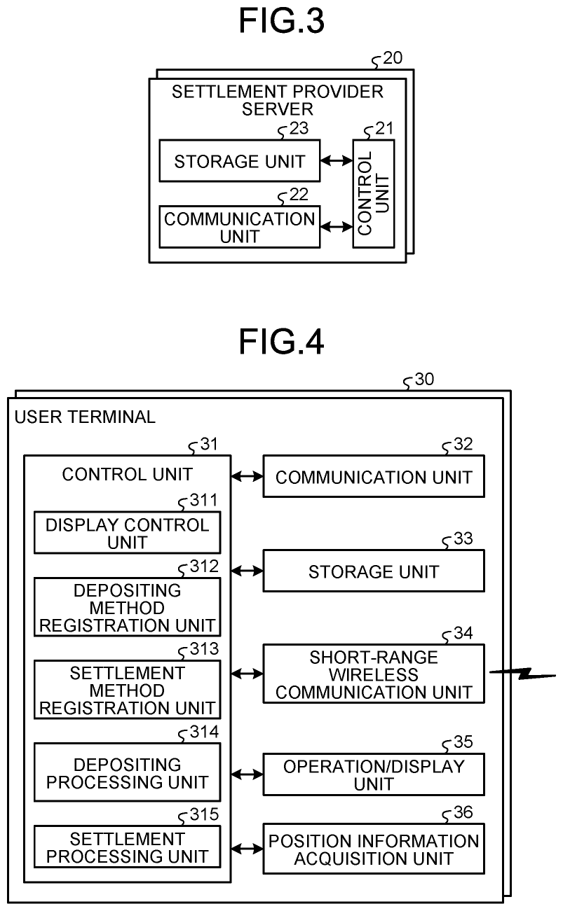

The settlement provider server 20 is a server for managing an account and a credit card of a user, and is provided in financial institutions (for example, banks, credit unions, credit associations, and labor banks) and credit card companies. As illustrated in FIG. 3, the settlement provider server 20 includes a control unit 21, a communication unit 22, and a storage unit 23. The control unit 21, the communication unit 22, and the storage unit 23 have physically similar configurations to the control unit 11, the communication unit 12, and the storage unit 13, respectively.

The storage unit 23 stores account information and credit card information for each user who uses the wallet system 1. Examples of the account information include a name of the user, an account number, an account balance, and a deposit/withdrawal history. In addition, examples of the credit card information include a name of the user, a credit card number, an expiration date of the credit card, use limit amount, and a card use history.

The user terminal 30 is a computer terminal used by a user. Examples of the user terminal 30 include a smartphone, a mobile phone, a tablet terminal, a wearable computer, a personal computer, and a route guidance device mounted on a vehicle, which are owned by a user. The user terminal 30 may be any terminal as long as information communication with the wallet server 10 may be performed.

As illustrated in FIG. 4, the user terminal 30 includes a control unit 31, a communication unit 32, a storage unit 33, a short-range wireless communication unit 34, an operation/display unit 35, and a position information acquisition unit 36. The control unit 31, the communication unit 32, and the storage unit 33 have physically similar configurations to the control unit 11, the communication unit 12, and the storage unit 13, respectively. The control unit 31 functions as a display control unit 311, a depositing method registration unit 312, a settlement method registration unit 313, a depositing processing unit 314, and a settlement processing unit 315 through execution of a computer program.

The display control unit 311 controls display contents on the operation/display unit 35. On the basis of operation of a user (touch operation, flick operation, and the like), the display control unit 311 displays, on the operation/display unit 35, a member registration screen for the user to register as a member, a login screen for the user to log in to the wallet server 10, a depositing screen for the user to deposit electronic money into the wallet, a settlement screen for the user to perform settlement, a use history screen showing a list of use histories of settlement and the like, a payment history detail screen showing details of payment history, a code payment screen, a scan payment screen, and the like. The display control unit 311 also performs transition of each screen on the basis of operation of the user. Note that various configurations may be adopted for screen configurations of the settlement screen, the use history screen, the payment history detail screen, and the code payment screen.

The depositing method registration unit 312 registers a depositing method for depositing electronic money. Specifically, the depositing method registration unit 312 transmits, to the wallet server 10, a depositing method registration request for registering a plurality of different payment methods (for example, a bank account, a credit card, and a virtual credit card) operated by a plurality of companies as depositing methods into the wallet. When receiving the depositing method registration request from the depositing method registration unit 312, the control unit 11 of the wallet server 10 stores, in the storage unit 13, the payment methods included in the depositing method registration request as the user information 131 to register the payment methods as the depositing methods.

The depositing method registration unit 312 registers the payment method to be registered as the settlement method also as the depositing method. That is, when a settlement method registration request is transmitted from the settlement method registration unit 313 to the wallet server 10, the depositing method registration unit 312 transmits, to the wallet server 10, the depositing method registration request for registering the payment methods included in the settlement method registration request as the settlement methods. When receiving the depositing method registration request from the depositing method registration unit 312, the control unit 11 of the wallet server 10 stores, in the storage unit 13, the payment methods included in the depositing method registration request as the user information 131 to register the payment methods as the depositing methods.

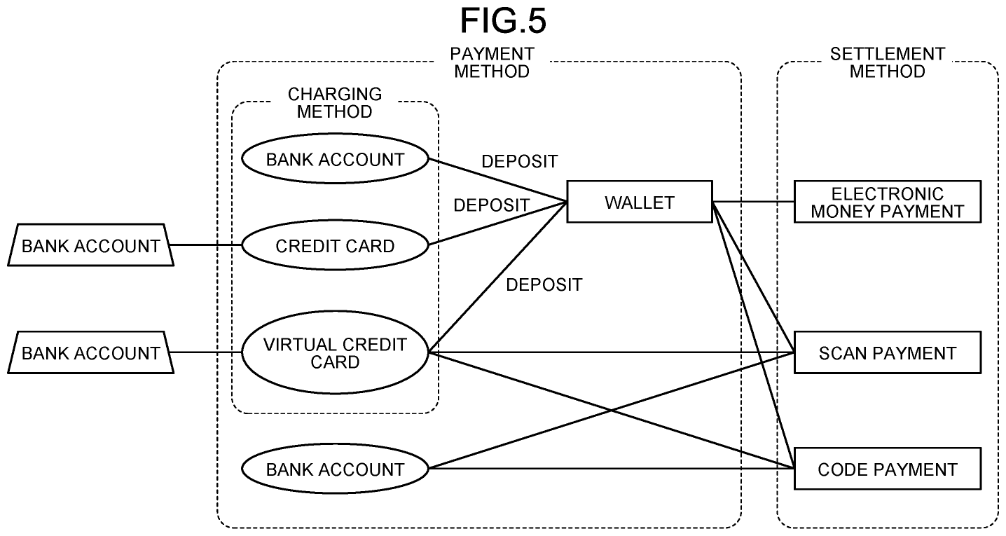

FIG. 5 is a diagram schematically illustrating a relationship among the payment method, the depositing method, and the settlement method. The “payment method” refers to a method that serves as funds for payment (funding source) when settlement is performed. Examples of the payment method include a bank account, a credit card, a virtual credit card, and a balance of electronic money in the wallet. The virtual credit card is an insubstantial credit card, and includes, for example, information such as a card number, an expiration date, and an authentication number (security code). In addition, a bank account is associated with each of the credit card and the virtual credit card, and a use amount of each card is withdrawn from the bank account at a later date.

The “depositing method” refers to a method for depositing electronic money into the wallet serving as a virtual deposit/withdrawal account. Examples of the depositing method include the bank account, the credit card, and the virtual credit card among the payment methods. By registration of the bank account, the credit card, and the virtual credit card as the depositing methods, it becomes possible to deposit electronic money into the wallet.

The “settlement method” refers to a method of performing settlement by using the payment method. Examples of the settlement method include electronic money payment, scan payment, and code payment. The electronic money payment is settlement performed in a contactless manner between the short-range wireless communication unit 34 of the user terminal 30 and a short-range wireless communication unit 46 of the vehicle 40 by holding the user terminal 30 over a predetermined position of the vehicle 40. The scan payment is settlement performed by reading a barcode or QR code (registered trademark) displayed on the vehicle 40 with a camera or the like of the user terminal 30. The code payment is settlement performed by reading a barcode or QR code (registered trademark) displayed on the user terminal 30 with a code reader or the like of the vehicle 40.

In the wallet system 1, any of the three types of the settlement method may be used by using the three types of the payment method. That is, in the wallet system 1, the payment method and the settlement method may be combined as described in (1) to (3) below.

(1) Electronic money payment, scan payment, and code payment using a balance of electronic money in the wallet.

(2) Electronic money payment, scan payment, and code payment using a virtual credit card.

(3) Electronic money payment, scan payment, and code payment using a bank account.

In the wallet system 1 of the present embodiment, electronic money may be deposited into the wallet by the plurality of payment methods, and a balance of electronic money deposited in the wallet may be settled through the plurality of settlement methods.

Return to FIG. 4. The settlement method registration unit 313 registers the payment method to be registered as the depositing method also as the settlement method. That is, when the depositing method registration request is transmitted from the depositing method registration unit 312 to the wallet server 10, the settlement method registration unit 313 transmits, to the wallet server 10, a settlement method registration request for registering the payment methods included in the depositing method registration request as the settlement methods.

For example, when registering a certain payment method (bank account of A bank) as the depositing method, the settlement method registration unit 313 automatically registers the payment method (bank account of A bank) also as the settlement method. Note that “register the payment method as the settlement method” means enabling settlement using the payment method as a payment source, for example, enabling electronic money payment, scan payment, and code payment using the bank account of the A bank as a payment source. When receiving the settlement method registration request from the settlement method registration unit 313, the control unit 11 of the wallet server 10 stores, in the storage unit 13, the payment methods included in the settlement method registration request as the user information 131 to register the payment methods as the settlement methods.

The depositing processing unit 314 deposits electronic money into the wallet. Specifically, the depositing processing unit 314 transmits, to the wallet server 10, a depositing request for depositing electronic money into the wallet by the payment method registered as the depositing method. When receiving the depositing request from the depositing processing unit 314, the control unit 11 of the wallet server 10 increases a balance of electronic money in the wallet on the basis of deposit amount information included in the depositing request. That is, the control unit 11 updates the wallet information 132 stored in the storage unit 13 in accordance with the increase in the balance of the electronic money in the wallet.

The settlement processing unit 315 performs settlement by the payment method. The settlement processing unit 315 transmits, to the vehicle 40 on which a user is riding, a settlement request for performing settlement by electronic money deposited into the wallet by using one of the plurality of settlement methods (electronic money payment, scan payment, and code payment) set in advance. For example, when electronic money payment is performed, the settlement processing unit 315 transmits the settlement request to the vehicle 40 through the short-range wireless communication unit 34. In addition, when scan payment is performed, the settlement processing unit 315 transmits the settlement request to the vehicle 40 by reading a barcode or QR code (registered trademark) displayed on the vehicle 40 with the camera or the like of the user terminal 30. In addition, when code payment is performed, the settlement processing unit 315 transmits the settlement request to the vehicle 40 by reading a barcode or QR code (registered trademark) displayed on the user terminal 30 with the code reader or the like of the vehicle 40. Note that the settlement request transmitted from the settlement processing unit 315 to the vehicle 40 may or may not include information indicating a settlement amount (hereinafter referred to as “settlement amount information”).

Subsequently, a control unit 41 of the vehicle 40 transmits the settlement request including the settlement amount information to the wallet server 10 via the network 2. When receiving the settlement request from the vehicle 40, the settlement processing unit 111 of the wallet server 10 decreases a balance of electronic money in the wallet on the basis of the settlement amount information included in the settlement request. That is, the settlement processing unit 111 updates the wallet information 132 and the settlement information 133 stored in the storage unit 13 in accordance with the decrease in the balance of the electronic money in the wallet.

Note that the settlement processing unit 315 may also perform settlement by the payment method other than the balance of the electronic money in the wallet (for example, a bank account or a credit card). In this case, the settlement processing unit 315 transmits, to the wallet server 10, a settlement request for performing settlement by a bank account or a credit card by using one of the plurality of settlement methods. When receiving the settlement request from the settlement processing unit 315, the settlement processing unit 111 of the wallet server 10 transmits the settlement amount information included in the settlement request to the settlement provider server 20.

The storage unit 33 stores data of various screens to be displayed by the display control unit 311 on the operation/display unit 35. In addition, the storage unit 33 continuously or temporarily stores the user information 131, the wallet information 132, the settlement information 133, and the like, as needed.

The short-range wireless communication unit 34 has a communication function conforming to a standard such as near field radio communication (NFC), Bluetooth (registered trademark) low energy (BLE), or Infrared Data Association (IrDA), for example. For example, when performing electronic money payment, the user terminal 30 performs short-range wireless communication with the vehicle 40 through the short-range wireless communication units 34 and 46.

The operation/display unit 35 includes a touch panel display, for example, and has an input function for accepting operation by a finger of a user, a pen, or the like, and a display function for displaying various types of information under control of the display control unit 311.

The position information acquisition unit 36 receives, for example, radio waves from a global positioning system (GPS) satellite and detects a position of the user terminal 30. Information regarding the position of the user terminal 30 detected by the position information acquisition unit 36 is stored in the storage unit 33.

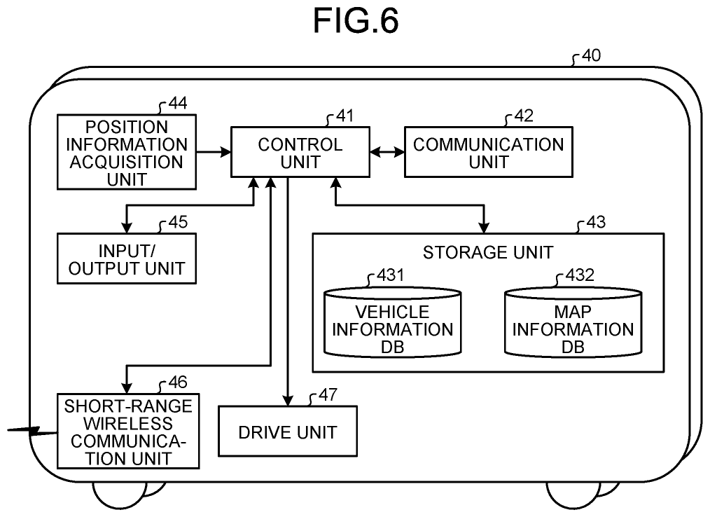

The vehicle 40 is a vehicle that travels by driving by a driver, or an autonomous traveling vehicle capable of autonomous traveling in accordance with a given traveling command. As illustrated in FIG. 6, the vehicle 40 includes the control unit 41, a communication unit 42, a storage unit 43, a position information acquisition unit 44, an input/output unit 45, the short-range wireless communication unit 46, and a drive unit 47.

The control unit 41, the communication unit 42, the storage unit 43, and the short-range wireless communication unit 46 have physically similar configurations to the control unit 11, the communication unit 12, the storage unit 13, and the short-range wireless communication unit 34, respectively.

The control unit 41 comprehensively controls operation of various components mounted on the vehicle 40.

The communication unit 42 includes a data communication module (DCM) that performs information communication with the wallet server 10 by wireless communication via the network 2.

The storage unit 43 includes a vehicle information database (vehicle information DB) 431 and a map information database (map information DB) 432. The vehicle information database 431 stores, in an updatable manner, various types of information including a vehicle ID of the vehicle 40, a user ID of a driver of the vehicle 40, a SOC of a battery mounted on the vehicle 40, a fuel remaining amount of the vehicle 40, travel route information of the vehicle 40, and vehicle type information of the vehicle 40.

The map information DB 432 stores map information. Here, the map information is information necessary for specifying positions of a road, a road structure, a facility, and the like, and includes, for example, data related to each node set on the road (for example, a node ID and coordinates), data related to each link set on the road (for example, a link ID, a link name, a connection node ID, road coordinates, a road type (a toll road, a general road, and the like), and the number of lanes), and feature data (for example, a traffic signal, a road sign, a guardrail, and a facility).

The position information acquisition unit 44 has a physically similar configuration to the position information acquisition unit 36. Position information of the vehicle 40 detected by the position information acquisition unit 44 is stored in the vehicle information database 431 in a retrievable manner. Note that, as a method of detecting a position of the vehicle 40, a method combining light detection and ranging or laser imaging detection and ranging (LiDAR) and a three-dimensional digital map may be adopted.

The input/output unit 45 includes a touch panel display and a speaker microphone. The input/output unit 45 as an output unit may notify the outside of predetermined information by displaying characters, graphics, and the like on a screen of the touch panel display or outputting sound from the speaker microphone, under control of the control unit 41. In addition, the input/output unit 45 as an input unit may input predetermined information to the control unit 41 by a user or the like operating the touch panel display or generating sound toward the speaker microphone. Note that, although the vehicle 40 includes the position information acquisition unit 44 and the input/output unit 45 as separate functions in the present embodiment, the vehicle 40 may include, instead of the position information acquisition unit 44 and the input/output unit 45, an in-vehicle navigation system with a communication function having functions of the position information acquisition unit 44 and the input/output unit 45.

The short-range wireless communication unit 46 has a communication function conforming to a standard such as NFC, BLE, or IrDA, for example, and is provided at a predetermined position of the vehicle 40. When a user, for example, performs electronic money payment, by holding the user terminal 30 over a predetermined position, short-range wireless communication is executed through the short-range wireless communication unit 46 with the user terminal 30.

The drive unit 47 is a drive unit that performs driving necessary for traveling of the vehicle 40. Specifically, the vehicle 40 includes an engine as a drive source, and the engine may generate power by using an electric motor or the like by being driven by combustion of fuel. The generated power is charged into a rechargeable battery. The vehicle 40 also includes a drive transmission mechanism that transmits driving force of the engine, driving wheels for traveling, and the like.

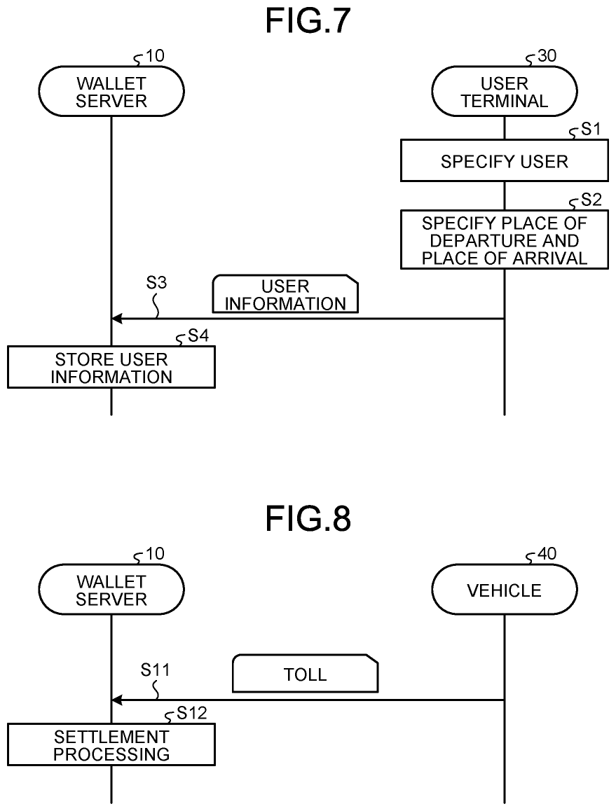

The wallet system 1 having such configurations improves convenience of a settlement service by executing the following recording processing and settlement processing. Hereinafter, operation of the wallet system 1 when executing the recording processing and the settlement processing will be described with reference to FIGS. 7 and 8.

FIG. 7 is a timing chart illustrating a flow of the recording processing according to an embodiment. The timing chart illustrated in FIG. 7 starts at a timing when a command to execute the recording processing is input to the control unit 31 via the operation/display unit 35 of the user terminal 30, and the recording processing proceeds to processing of Step S1.

In the processing of Step S1, the control unit 31 of the user terminal 30 prompts input of information specifying a user who bears a toll of the vehicle 40 via the operation/display unit 35. The control unit 31 then stores the input information in response to the input of the information specifying the user via the operation/display unit 35. Thus, the processing of Step S1 is completed, and the recording processing proceeds to processing of Step S2.

In the processing of Step S2, the control unit 31 of the user terminal 30 prompts input of information specifying a travel section (place of departure and place of arrival) of the vehicle 40, for which a toll of the vehicle 40 is born, via the operation/display unit 35. The control unit 31 then stores the input information in response to the input of the information specifying the travel section via the operation/display unit 35. Thus, the processing of Step S2 is completed, and the recording processing proceeds to processing of Step S3.

In the processing of Step S3, the control unit 31 of the user terminal 30 generates user information obtained by combining the information stored in the processing of Step S1, the information stored in the processing of Step S2, and a user ID of the user information 131 stored in the storage unit 33. The control unit 31 then transmits, via the communication unit 32, the generated user information to the wallet server 10. Thus, the processing of Step S3 is completed, and the recording processing proceeds to processing of Step S4.

In the processing of Step S4, the control unit 11 of the wallet server 10 receives the user information via the communication unit 12, and stores the received user information in the user information 131 of a user corresponding to the user ID included in the user information. Thus, the processing of Step S4 is completed, and a series of the recording processing ends.

FIG. 8 is a timing chart illustrating a flow of settlement processing according to an embodiment. The timing chart illustrated in FIG. 8 starts at a timing when an ignition switch of the vehicle 40 of the user who is specified in the recording processing and bears the toll is switched from an OFF state to an ON state, and the recording processing proceeds to processing of Step S11.

In the processing of Step S11, the control unit 41 of the vehicle 40 transmits, via the communication unit 42, information regarding the toll when the vehicle 40 passes an ETC to the wallet server 10. Thus, the processing of Step S11 is completed, and the settlement processing proceeds to processing of Step S12.

In the processing of Step S12, the control unit 11 of the wallet server 10 receives, via the communication unit 12, the information transmitted from the vehicle 40 in the processing of Step S11. Then, on the basis of the received information and the user information 131, the control unit 11 transmits the toll of the travel section specified in the recording processing to the user terminal 30, and executes settlement processing of the toll with the user terminal 30. Thus, the processing of Step S12 is completed, and a series of the settlement processing ends.

As is apparent from the above description, in the wallet system 1 according to an embodiment, the user terminal 30 outputs user information indicating a user who pays a toll of the vehicle 40, and the wallet server 10 specifies the vehicle of the user by using the user information, and executes settlement processing of the toll of the specified vehicle of the user with the user terminal 30. According to such a configuration, a service enabling another user to pay a toll may be implemented, so that convenience of a settlement service may be improved. Note that, in addition to the toll, a fuel cost of the vehicle 40 may also be paid. In addition, when there is a fellow passenger in the vehicle 40, a split cost may be paid. Furthermore, an appropriate refueling place may be guided in consideration of a cost and the like in accordance with a destination and an amount of remaining fuel of the vehicle 40.

According to the present disclosure, convenience of a settlement service may be improved.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A settlement system comprising:
a terminal device configured to be carried by a first user, the terminal device comprising
a first processor comprising hardware, the first processor being configured to output user information indicating a second user who pays a cost for traveling a vehicle by the first user; and
a server comprising
a second processor comprising hardware, the second processor being configured to
acquire the user information, and
execute settlement processing by the second user indicated by the user information for the cost for traveling the vehicle with the terminal device.

2. The settlement system according to claim 1, wherein
the first processor is configured to output information indicating a travel section of the vehicle for which the cost is paid, and
the second processor is configured to
acquire the information, and
execute the settlement processing of the cost in the travel section indicated by the acquired information with the terminal device.

3. The settlement system according to claim 1, wherein the cost includes a toll.

4. The settlement system according to claim 1, wherein the cost includes a fuel cost.

5. The settlement system according to claim 1, wherein the first processor is configured to execute settlement processing by electronic money payment.

6. The settlement system according to claim 1, wherein the first processor is configured to execute settlement processing by scan payment.

7. The settlement system according to claim 1, wherein the first processor is configured to execute settlement processing by code payment.

8. The settlement system according to claim 1, wherein the first processor is configured to execute settlement processing via a settlement application program.

9. A terminal device adopted to be carried by a first user, the terminal device comprising
a processor comprising hardware, the processor being configured to
output, to a server, user information indicating a second user who pays a cost for traveling a vehicle by the first user, and
execute settlement processing by the second user for the cost for traveling the vehicle with the server apparatus.

10. The terminal device according to claim 9, wherein the processor is configured to output, to the server, information indicating a travel section of the vehicle for which the cost is paid.

11. The terminal device according to claim 9, wherein the cost includes a toll.

12. The terminal device according to claim 9, wherein the cost includes a fuel cost.

13. The terminal device according to claim 9, wherein the processor is configured to execute settlement processing by electronic money payment.

14. The terminal device according to claim 9, wherein the processor is configured to execute settlement processing by scan payment.

15. The terminal device according to claim 9, wherein the processor is configured to execute settlement processing by code payment.

16. The terminal device according to claim 9, wherein the processor is configured to execute settlement processing via a settlement application program.

17. A non-transitory computer-readable recording medium on which an executable program is recorded, the program causing a processor of a computer to execute:
outputting, to a server, user information indicating a second user who pays a cost for traveling a vehicle by the first user; and
performing settlement processing by the second user for the cost for traveling the vehicle with the server apparatus.

18. The non-transitory computer-readable recording medium according to claim 17, wherein the program causes the processor to execute:
outputting, to the server, information indicating a travel section of the vehicle for which the cost is paid.

19. The non-transitory computer-readable recording medium according to claim 17, wherein the cost includes a toll.

20. The non-transitory computer-readable recording medium according to claim 17, wherein the cost includes a fuel cost.
